(19) United States
(12) Patent Application Publication
(10) Pub. No.: US 2026/0094150 A1
(43) Pub. Date: Apr. 2, 2026

(54) SYSTEMS AND METHODS FOR INTEGRATING ENHANCED AUTHENTICATION

(71) Applicant: MASTERCARD INTERNATIONAL INCORPORATED, PURCHASE, NY (US)

(72) Inventors: Florent HAY, Laeken (BE); Qing CAO, Purchase, NY (US)

(21) Appl. No.: 19/309,208

(22) Filed: Aug. 25, 2025

Related U.S. Application Data
(60) Provisional application No. 63/700,468, filed on Sep. 27, 2024.

(51) Int. Cl. G06Q 20/38; G06Q 20/32; G06Q 20/40

(52) U.S. Cl. CPC G06Q 20/38215; G06Q 20/3278; G06Q 20/40145

(57) ABSTRACT

Systems and methods are provided for use in registering a card device as an authenticator. One example method includes, in response to a request to register a card device as an authenticator, soliciting, by a mobile device, a challenge from an authentication server; receiving, in response to the request, the challenge from the authentication server; passing, by the mobile device, the challenge to the card device; signing, by the card device, the challenge; compiling, by the card device, an assertion, which includes the signed challenge, a card certificate, an issuer certificate and an identifier associated with the card device; returning, by the card device, the assertion to the mobile device; and passing the assertion to the authentication server, whereby verification of the card certificate, the issuer certificate and the signed challenge based on a public key included in the card certificate enables registration of the card device as the authenticator.

### CROSS-REFERENCE TO RELATED APPLICATION

This application claims the benefit of, and priority to, U.S. Provisional Patent Application No. 63/700,468 , filed on Sep. 27, 2024. The entire disclosure of the above application is incorporated herein by reference.

### FIELD

The present disclosure is generally directed to systems and methods for use in integrating enhanced authentication to configure card devices as passkey authenticators.

### BACKGROUND

This section provides background information related to the present disclosure which is not necessarily prior art.

Certain cards are known to be configured for contactless communication. For example, a credit card may include a near-field communication (NFC) chip to enable payment credentials to be passed to a point-of-sale (POS) terminal, through “tapping” or contactless interaction between the credit card and the POS terminal. For MASTERCARD branded contactless cards, for example, the cards each include an EMV chip, which enables the above communication consistent with EMV standards (e.g., as described at www.emvco.com, etc.). The EMV chip relies on a complex software stack, being integrated into a device, to establish communication between the device and the EMV chip in the card and to communicate consistent with an EMV compliance format. The EMV chip is then known to be accessible through a software component, which is disseminated to card terminal device manufacturers to enable the contactless communication with such terminals (e.g., point of sale (POS) terminals, etc.).

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in integrating enhanced authentication to configure card devices as passkey authenticators;

FIG. 2 is a block diagram of an example computing device that may be used in the system of FIG. 1;

FIG. 3 illustrates an example method, which may be implemented in connection with the system of FIG. 1, for use in integrating enhanced authentication to configure card devices as passkey authenticators; and

FIG. 4 illustrates another example method, which may be implemented in connection with the system of FIG. 1, for use in integrating enhanced authentication to configure card devices as passkey authenticators.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Payment cards are used in connection with account transactions, to identify accounts as sources, or recipients, of funds. Chip-type payment cards go beyond conventional cards to permit enhanced authentication, through the EMV technology (e.g., as described at www.emvco.com, etc.) and/or contactless communication (e.g., as defined by www.emvco.com, through m/chip technology, as indicated by MASTERCARD card specification, etc.). Robust security and complexity behind the m/chip technology, for example, integrated for the above technology, provides limited ability to layer on functionality to the chip. As such, the functionality of the cards incorporating the m/chip technology may be limited, absent an improve technical approach to the card design.

Uniquely, the systems and methods herein provide use of a card device as an authenticator, for fast identity online (FIDO) type authentication of a user (e.g., where the card device includes the m/chip technology, permits EMV-based authentication, etc.). In particular, the card device is adapted to communicate consistent with the Client to Authenticator Protocol (CTAP) standard protocol, in addition to the EMV standard protocol, whereby the card device implements FIDO authentication protocol, using EMV-based personalization elements originally provisioned to perform EMV transactions. In this way, through adapting the card device to the CTAP protocol, the card device is permitted to be authenticated by one or more certificates therein, which permits, in turn, leveraging the card private key therein specific to the card device to act as the FIDO authenticator. Consequently, the card device is available to authenticate the user in connection with one or more relaying parties (e.g., login, account access, services, etc.).

As such, the systems and methods herein define a technical solution as it relates to data security, to the limited use of the card device by extending its use as an authenticator, through implementation that may or may not require registration of the card device with an authentication server, etc.

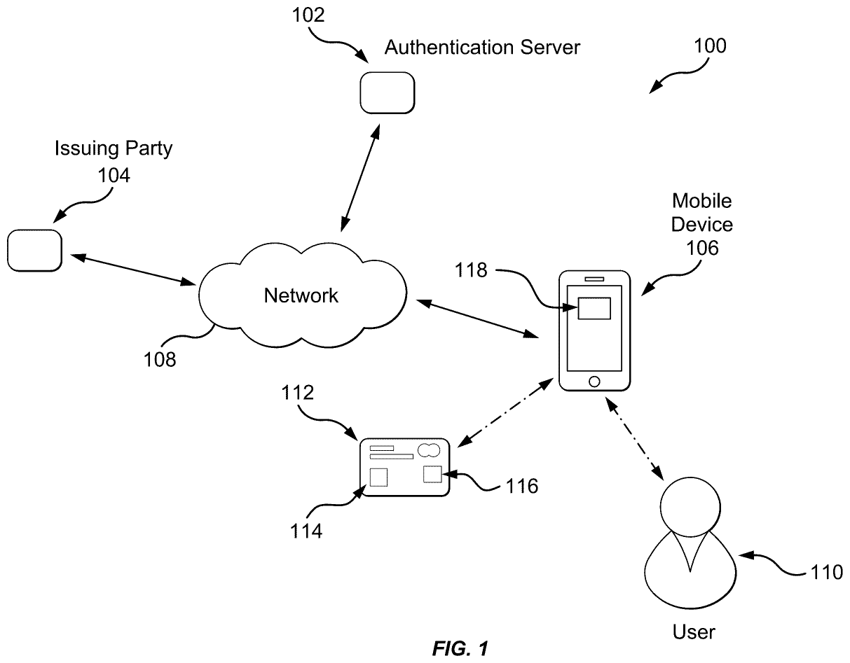

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between users and payment account and/or payment card issuers, types of card devices, privacy requirements, etc.

The system 100 generally includes an authentication server 102, an issuing party 104, and a mobile device 106, each of which is coupled to network 108. The network 108 may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, in at least one embodiment, the network 108 may include a private network through which the issuing party 104 is coupled in communication to the authentication server 102, and a public network (e.g., the Internet, etc.) through which the mobile device 106 is coupled to the issuing party 104, for example.

In this example embodiment, the authentication server 102 is configured to support extended fast identity online (FIDO) protocol and to participate in authentication of a user, such as, for example, user 110, in connection with a FIDO-like authentication consistent with, for example, the Client to Authenticator Protocol (CTAP) standard available at https://fidoalliance.org/. It should be appreciated that one or more various forms of the above protocol may be employed, or other protocols may be employed with the authentication server 102, based on, for example, the particular implementation.

It should also be appreciated that the authentication server 102 may be a stand alone server, or may be part of another entity. In various examples, the authentication server 102 is part of a processing network, such as, for example the MASTERCARD authentication processing network, etc.

In addition to the above, the authentication server 102 is associated with a domain, whereby the authentication service is accessible to one or more relying parties (not shown). The domain may be specific to one relying party, whereby the domain is identified by a relying party identifier, or RP ID. One example domain may include a website, such as, for example, secure.processing.rpdomain.com. It should be appreciated that the domain limits usage of the authentication service, whereby multiple domains may be defined by the authentication server 102 to access the authentication service.

In the example embodiment, the issuing party 104 is a financial institution, which is configured to issue accounts to users, such as, for example, the user 110. The account may include, without limitation, a financial account (e.g., a credit account, a debit account, a prepaid account, etc.), an insurance account, a medical account, etc. In connection with issuing the account, the issuing party 104 is also configured to issue a physical card device 112, which is linked and/or specific to the account. The card device 112 may include a credit card, for example, as shown in FIG. 1.

The card device 112 may be subject to and may comply with the ISO/IEC 7810 ID-1 standard, which generally indicates the physical dimensions and/or dimensional proportions of the payment card 112 (e.g., the card device 112 may have dimensions of about 3.375 inches (about 85.60 mm) by about 2.125 inches (about 53.98 mm); etc.) (although this is not required in all embodiments). Having these dimensions, or these approximate dimensions, defines the card device as a “card” device in that the card device takes on the shape of a card. As such, the term “card device” is not inclusive of a smartphone, a smart watch, or a key fob, etc.

In addition, and as described above, the card device 112 includes a chip 114, which is configured consistent with the EMV standard protocol (e.g., as described at www.emvco.com, etc.). In this manner, the chip 114 includes a card certificate, an issuer certificate and a card private key. The card certificate includes, among other things, a card public key corresponding to the card private key and a signature, generated using the issuer private key. The issuer certificate includes, among other things a public key corresponding to the issuer private key and a signature, generated using a certificate authority private key (of a certification authority key pair) (e.g., associated with the authentication server 102, etc.). The certificate authority key pair is associated with a processing network, with which the account linked to the card device 112 is associated (e.g., MASTERCARD processing network, etc.). And, the card private key is a key specific to the card device 112, which is stored in a secure location within the chip 114. The card private key is generally inaccessible to external devices interacting with the card device 112, while being generally usable within the chip 114. The chip 114 also includes a primary account number or PAN, an expiration date, etc. for the account linked to the card device 112.

The chip 114 is also understood to be configured to enable contactless communication to/from the card device 112. That is, the chip 114 is configured to participate in near-field communication (NFC) interactions (or communications) with a device, such as, for example, the mobile device 106, when within the range of the card device 112. In this manner, for example, the chip 114 configures the card device 112 to comply with one or more NFC standards to enable such contactless communication. NFC permits two-way interactions between different devices (e.g., between the mobile device 106 and the card device 112, etc.) through elements in existing standards for contactless card technology, such as, for example, ISO/IEC 14443 A&B, JIS-X 6319-4, etc.

Specifically, the chip 114 is configured with tap-to-pay functionality, consistent with the EMV standard protocol, whereby a cryptogram generated by the chip 114 is retrieved by the nearby mobile device 112 and can be used for authentication, which necessitates the implementation of a so-called EMV contactless kernel (e.g., a different kernel is used depending on the processing network, etc.), which allows establishing the communication protocol with the EMV chip device. Such “kernel” is always considered a “proprietary” software stack and might not always be permitted by the operating system of the mobile device 112. The tap-to-pay functionality of the card device 112 is configured through an application or instructions included in the chip 114, to communicate consistent with the EMV standard protocol. The application, or the tap-to-pay functionality thereof, is associated with a first application identifier or AID. The first AID may be unique to the issuer party 104 of the card device 112, the processing network associated with the card device 112, etc. As such, to initiate the tap-to-pay functionality, the first AID is communicated to the card device 112, as part of establishing communication therewith.

In this example embodiment, in addition to the above, the card device 112 may further include one or multiple RP ID (or Relying Party Identifier), which may be specific to a domain name (e.g., authenticate.mybank.com, etc.), etc., and which may be used to support the FIDO authenticator functionalities of the card device 112. The FIDO authenticator functionality of the chip 114 is embodied in the application (or a separate application) in the card device 112, which is configures the card device 112 to communicate consistent with the CTAP standard protocol available at https://fidoalliance.org/ and identified by a second AID, which is distinct from the first AID, so that either functionality may be initiated through contactless communication with the card device 112. As such, to initiate the FIDO authenticator functionality, the second AID is used to communicate to the card device 112, as part of establishing communication therewith.

In one or more embodiments, the card device 112 is configured as (or includes) a biometric-enabled sensor 116, which is coupled to the chip 114 and configured, in turn, to the capture a biometric of the user 110. In connection therewith, the chip 114 further includes a biometric reference. The card device 112 may be configured, in connection with one or more flows, to capture a biometric of the user 110 and to compare the captured biometric to the reference biometric. The card device 112, consequently, is configured to authenticate the user 110 when the captured biometric matches the biometric reference. Additionally, or alternatively, the biometric-enabled sensor 116 may be omitted in favor of PIN authentication, between the card device 112 and the mobile device 106, whereby the user 110 enters a PIN to the mobile device 106, which is verified in the card device 112, as above for the biometric.

It should be appreciated that the card device 112 may be configured, or not, to enforce one or more forms of authentication, such as, for example, biometric, PIN, etc., to access the card private key for use as described herein, or alternatively may be configured to not ask for any additional authentication factor, except the possession factor provided when presenting the card device 112 to mobile device 106.

With continued reference to FIG. 1, the mobile device 106 includes a smartphone, laptop, tablet, or other communication device, which is generally mobile, and equipped with NFC communication capabilities. It should be appreciated that the mobile device 106 may be replaced with one or more immobile devices in other embodiments. As shown, the mobile device 106 includes an application 118, which includes executable instructions to configure the mobile device 106 as described herein. The application 118 is downloaded to and/or installed in the mobile device 106. In the illustrated embodiment, the application 118 is associated with the relying party, and may be further associated with the authentication server 102. In particular, the application 118 configures the mobile device 106, similar to the card device 112, to be consistent with the CTAP standard available at https://fidoalliance.org/.

The application 118 may be specific to the authentication server 102, or include a software development kit (SDK) specific to the authentication server 102. In the later example, the application 118 may be specific to a relying party, such as, for example, an account provider (e.g., issuing party 104, etc.). The authentication of the user 110 through the authentication server 102, then, may be employed by the application 118, in the appropriate domain, to permit access to the account, through the mobile device 106, as assurance of the user's authorized access thereto.

In connection with the above, the card device 112 is configured as a roaming FIDO authenticator device. In one implementation, registration of the card device 112 for FIDO authentication is employed, and in another implementation, no registration of the card device 112 is employed.

In particular, in the first implementation, the user 110 accesses the application 118, which configures the mobile device 106 to solicit the user 110 to tap the card device 112 on the mobile device 106 to register for FIDO-based authentication. In connection therewith, the mobile device 106 is configured, by the application 118, to solicit a registration challenge from the authentication server 102. The authentication server 102, in response, is configured to return a challenge to the mobile device 106.

Optionally, the mobile device 106 may solicit a knowledge-based factor such as a PIN (authentication input) from the user 110, which the user 110 then enters, or instructs the user 110 to utilize the biometric sensor 116, when tapping the card device on the mobile device 106, whereby a biometric (authentication input) is captured by the card device 112.

In response, the user 110 taps the card device 112 on the mobile device 106, or otherwise brings the card device 112 within the contactless range of the mobile device 106, whereupon contactless communication is established therebetween, through use of the second AID (i.e., the mobile device 106 passes the second AID specific to the FIDO authenticator functionalities).

As part thereof, the mobile device 106 is configured to pass the challenge from the authentication server 102 (and the knowledge-based factor if applicable) to the card device 112. The card device 112 is configured to optionally verify the authentication input and, if successful (if applicable), to sign the challenge with the EMV card private key. In this way, the card device 112 omits generating a separate key pair (e.g., private-public key pair, etc.) for the FIDO authentication registration, by relying on the existing card private key therein, which is used as a trusted anchor to perform the initial identity verification process. The card device 112 is configured to then compile a FIDO assertion that contains the signed challenge, with additional data that will allow the identity verification process, which includes among other things the card certificate, the issuer certificate and the PAN. The card device 112 is configured to pass the assertion and the RP ID, via the NFC interface, to the mobile device 106. The card device 112 may pass a device ID and/or a credential ID specific to the FIDO authentication with the specific card device 112 (in lieu of the PAN, or in addition thereto) to the authentication server 102, in one or more examples.

The mobile device 106 is configured to transmit the FIDO assertion, via the domain identified by the RP ID, to the authentication server 102. In this example embodiment, the authentication server 102 is configured to verify the card certificate (e.g., using the issuer public key present in the issuer certificate, etc.) and to verify the issuer certificate (e.g., based on a CA public key, etc.), consistent with the EMV standard protocol. It should be appreciated that in the system 100, the verification of the certificates, is moved from a POS terminal to the authentication server 102, as compared to conventional EMV presentment.

Once the certificates are verified, the authentication server 102 is configured to extract the card public key from the card certificate and verify the signature on the challenge (which was signed by the card private key at the card device 112) with the card public key.

When the signature on the challenge is verified, the authentication server 102 is configured to generate a user ID, to map the PAN to the user ID, and then to store the card public key linked to the user ID. The authentication server 102 is configured to then respond to the mobile device 106 with a notification of the registration of the card device 112 as a FIDO authentication and the user ID. The mobile device 106 is configured, by the application 118, to then store the user ID in the card device 112. In this manner, the FIDO authentication is available, using the card device 112, as a FIDO authenticator, by passing the user ID, as compared to the PAN for each authentication.

Alternatively, or additionally, the authentication server may be configured to, after verifying the signature, store the card public key linked to either the credential ID or the device ID, whereby, again, the PAN is then not needed to be passed for each FIDO authentication, which may ease the compliance to standards such as PCI DSS.

At this point the user registration of the card device 112 as a FIDO authentication is completed.

Subsequently, when the user 110 is required to authenticate at the mobile device 106, as configured by the application 118, the mobile device 106 is configured to request a challenge from the authentication server 102. The authentication server 102 is configured to generate a challenge and to return the challenge to the mobile device 106. The mobile device 106, in turn, is configured, by the application 118, to prompt the user 110 to tap the card device 112 on the mobile device 106, or otherwise brings the card device 112 within the contactless range of the mobile device 106, to initiate the FIDO authenticator functionalities, through presenting the second AID specific to the FIDO authenticator functionalities.

In connection therewith, then, the mobile device 106 is configured to pass the challenge, from the authentication server 102, to the card device 112.

Optionally, the card device 112 is configured to authenticate the user 110, either through a knowledge-based factor such as a PIN at the mobile device 106, a biometric at the biometric sensor 116, or otherwise. Next, the card device 112 is configured to retrieve the card private key and to sign the challenge with the card private key. The card device 112 is configured to then return the signed challenge with the user ID (or credential ID or device ID) to the mobile device 106.

The mobile device 106 is configured to return the signed challenge with the user ID (or credential ID or device ID) to the authentication server 102. The authentication server 102 is configured to retrieve the card public key based on the user ID (or credential ID or device ID) and to verify the signature on the challenge using the card public key. Once the signed challenge is verified, the authentication server 102 is configured to return a notice of successful FIDO authentication, whereby the user 110 may be logged-in to the application 118 at the mobile device 106, or otherwise provided access to an account or service associated therewith, etc.

In the second implement, the card device 112 is preconfigured with the specific domain of the authentication server 102 and/or the domain supporting the card device as a FIDO authentication (or FIDO authenticator). Consequently, the user 110 is able to access the application 118, which configures the mobile device 106 to solicit the user 110 to tap the card device 112 on the mobile device 106 to gain access to the application, or an account or service associated therewith, through FIDO-based authentication. In connection therewith, the mobile device 106 is configured, by the application 118, to solicit a challenge from the authentication server 102. The authentication server 102, in response, is configured to return a challenge to the mobile device 106.

Optionally, the mobile device 106 may solicit a knowledge-based factor such as a PIN (authentication input) from the user 110, which the user 110 then enters, or instructs the user 110 to utilize the biometric sensor 116, when tapping the card device on the mobile device 106, whereby a biometric (authentication input) is captured by the card device 112.

In response, the user 110 taps the card device 112 on the mobile device 106, or otherwise brings the card device 112 within the contactless range of the mobile device 106, whereupon contactless communication is established therebetween, through use of the second AID to initiate the FIDO authenticator functionalities.

As part thereof, the mobile device 106 is configured to pass the challenge from the authentication server 102 (and the knowledge-based factor such as the PIN) to the card device 112. The card device 112 is configured to optionally verify the authentication input and, if successful (if applicable), to sign the challenge with the card private key. The card device 112 is configured to then compile a FIDO assertion, which includes the card certificate, the issuer certificate, the PAN, and the signed challenge. The card device 112 is configured to pass the assertion and the RP ID, via the contactless connection, to the mobile device 106.

The mobile device 106 is configured to transmit the FIDO assertion, via the domain identified by the RP ID, to the authentication server 102. In this example embodiment, the authentication server 102 is configured to verify the card certificate (e.g., based on an issuer public key, etc.) and to verify the issuer certificate (e.g., based on a network public key, etc.), consistent with the EMV standard protocol. Once the certificates are verified, the authentication server 102 is configured to extract the card public key from the card certificate and verify the signature on the challenge (which was signed by the card private key at the card device 112) with the card public key.

When the signature on the challenge is verified, the authentication server 102 is configured to return a notice of successful FIDO authentication, whereby the user 110 may be logged-in/authenticated to the application 118 at the mobile device 106, or otherwise provided access to an account or service associated therewith, etc.

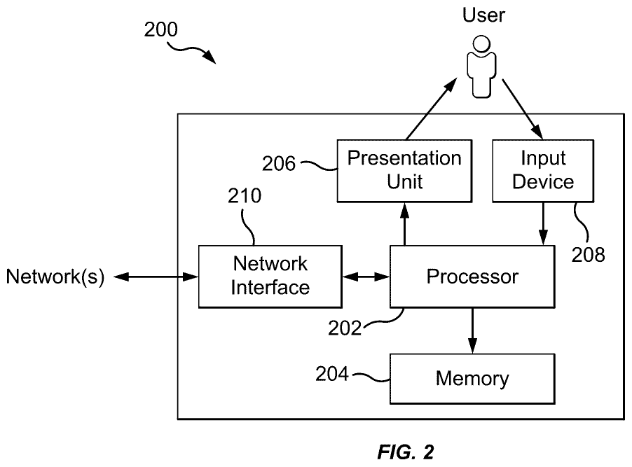

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the authentication server 102, the issuing party 104, and the mobile device 106 should be understood as including, or being implemented in, computing device 200, coupled to (and in communication with) one or more of the networks (e.g., the network 108, etc.). In addition, the card device 112 should be considered a computing device generally consistent with computing device 200 for purposes of the description herein.

Notwithstanding the above, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), an EMV chip, a microcontroller, a reduced instruction set computer (RISC) processor, an application specific integrated circuit (ASIC), a programmable logic device (PLD), a gate array, and/or any other circuit or processor structured (e.g., by executable instructions, or programming, etc.) (e.g., as indicated by the application 118 and/or a related SDK, etc.) to perform the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identity details and data related to identities of users, biometrics (e.g., reference biometrics, etc.), payment account credentials, and/or other types of data (and/or data structures) suitable for use as described herein.

Furthermore, in various embodiments, computer-executable instructions (e.g., in the form of the application 118, etc.) may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., prompts to the user 110 at the mobile device 106 to authenticate via a biometric, etc.), etc. And various interfaces (e.g., as defined by the application 118, etc.) may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200, such as, for example, biometrics, etc., in response to prompts from the application 118, as further described below. The input device 208 may include a single input device or multiple input devices. The input device 208 is coupled to (and is in communication with) the processor 202 and may include, for example, one or more of a keyboard, a biometric sensor, a pointing device, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

That said, it should be appreciated that certain computing devices, such as, for example, the card device 112, etc., may omit one or more of the input device 208 and/or the presentation unit 206 intended for user interaction, while including other components for facilitating computing device interactions (e.g., an EMV chip, magnetic strip, etc.).

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different ones of the networks herein and/or with other devices described herein. It should be appreciated that the computing device 200 may include multiple network interfaces 210, where the computing device 200 communicates via different networks. Further, in some example embodiments, the computing device 200 may include the processor 202 and one or more network interfaces incorporated into or with the processor 202.

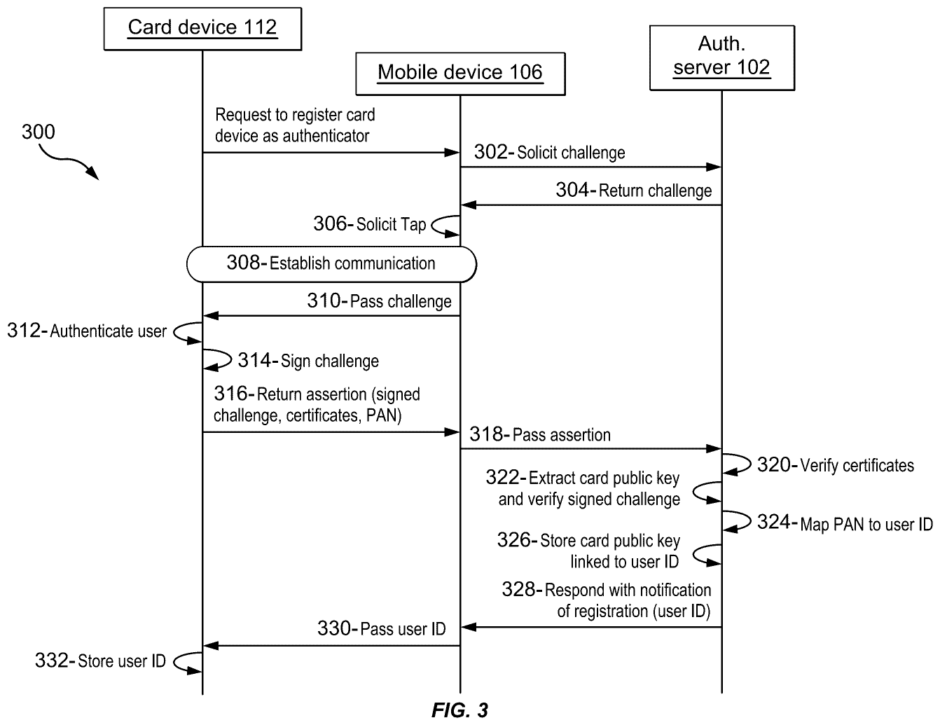

FIG. 3 illustrates an example method 300 for use in registering a card device as a FIDO authentication with a authentication server. The example method 300 is described as implemented in the authentication server 102, the mobile device 106, and the card device 112 of the system 100, etc. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset in the method 300, the user 110 accesses the application 118 at the mobile device 106 and requests to register the card device 112 as a FIDO authenticator with the authentication server 102 in a particular domain. In response, at 302, the mobile device 106 solicits a challenge from the authentication server 102. At 304, the authentication server generates and returns a challenge to the mobile device 106. The challenge may be any suitable string of letters and/or numbers, which is unique.

Next, at 306, the mobile device 106 solicits the user 110 to tap the card device 112 at the mobile device 106, or otherwise bring the card device 112 within the NFC range of the mobile device 106. Once within the range, at 308, communication is established between the mobile device 106 and the card device 112, and the FIDO authenticator functionalities are initiated in the card device 112, through presenting the second AID specific to those functionalities (as compared to the first AID specific to the EMV functionalities). In this embodiment, the communication is contactless, through NFC interfaces (e.g., network interface 210, etc.) in each of the card device 112 (e.g., the chip 114, etc.) and the mobile device 106. In other embodiments, the communication may include one or more other contactless protocols, or even contact based communication (e.g., where the card device 112 is at least partially inserted, or swiped, in a reader associated with the mobile device 106, etc.).

At 310, the mobile device 106 passes the challenge from the authentication server 102 to the card device 112. In response, at 312, optionally, the card device 112 authenticates the user 110. In one example, the card device 112 captures a biometric, via the biometric sensor 116, and compares the captured biometric to a reference biometric stored in the chip 114. When there is a match, the user 110 is authenticated, and the card device 112 is permitted to proceed. In another example, the mobile device 106 solicits a PIN from the user 110, prior to or at the same time as soliciting the challenge response from the user 110, whereupon the user 110 enters the PIN. In such an example, the mobile device 106 passes the PIN with the challenge to the card device 112, at 310. Then, at 312, the card device 112 compares the received PIN with a PIN reference stored in the chip 114. Again, when there is a match the user 110 is authenticated.

It should be appreciated that authentication of the user 110 may be optionally included as shown in FIG. 3, or may be included in other parts of the method 300 is appropriate. What's more, in various embodiments, the authentication of the user 110 may be omitted based on the other verifications described herein.

The card device 112 retrieves a private key from the chip 114 and signs, at 314, the challenge with the card private key. The card device 112 compiles a FIDO assertion, which includes the signed challenge as well as additional data allowing to bootstrap the card device 112 including, without limitation, the card certificate, the issuer certificate, and the PAN. At 316, the card device 112 returns the assertion and the RP ID, via the contactless connection, to the mobile device 106. While the PAN is included in the assertion in this example embodiment, the card device 112 may include one or more other identifiers in other embodiments. For example, the card device 112 may pass a device ID specific to the card device 112 (e.g., electronic serial number (ESN), etc.) and/or a credential ID, which is generated by the card device 112 and specific to the FIDO authentication with the card device 112. In at least one embodiment, the card device 112 passes the PAN along with one or more of the device ID and the credential ID.

At 318, the mobile device 106 passes the FIDO assertion, via the domain identified by the RP ID, to the authentication server 102.

The authentication server 102 verifies, at 320, the card certificate (e.g., based on an issuer key, etc.) and the issuer certificate (e.g., based on a network/CA public key, etc.), consistent with the EMV standard protocol, as explained above. Once the card certificate and the issuer certificate are verified, the authentication server 102 extracts, at 322, the card public key from the card certificate and verifies the signature on the challenge (which was signed by the card private key at the card device 112) with the card public key.

When the signature on the challenge is verified, the authentication server 102 generates a user ID and maps the user ID to the PAN from the assertion, at 324. The authentication server 102 then stores, at 326, the card public key for the card device 112 linked to the user ID, so that the card public key may be retrieved based on the user ID and subsequent authentications. In embodiments in which the PAN is omitted, the authentication server 102 may store the card public key linked to the device ID and/or the credential ID received as part of the assertion. The authentication server 102 responds, at 328, to the FIDO assertion with a notification of registration of the card device 112 as a FIDO authentication. When the user ID is generated and linked to the card public key, the authentication server 102 includes the user ID in the notification of registration. In such embodiments, the mobile device 106 passes, at 330, the user ID back to the card device 112. The card device 112 then stores, at 332, the user ID in the chip 114. In this manner, the FIDO authentication is available, using the card device 112, as an authenticator, by passing the user ID, as compared to the PAN for each authentication.

At this point the user registration of the card device 112 as a FIDO authenticator is complete, whereby the card device 112 may be used for future authentication of the user 110, through tapping or otherwise presenting the card device 112 to the mobile device 106, within the domain and initiating the FIDO authenticator functionalities therein.

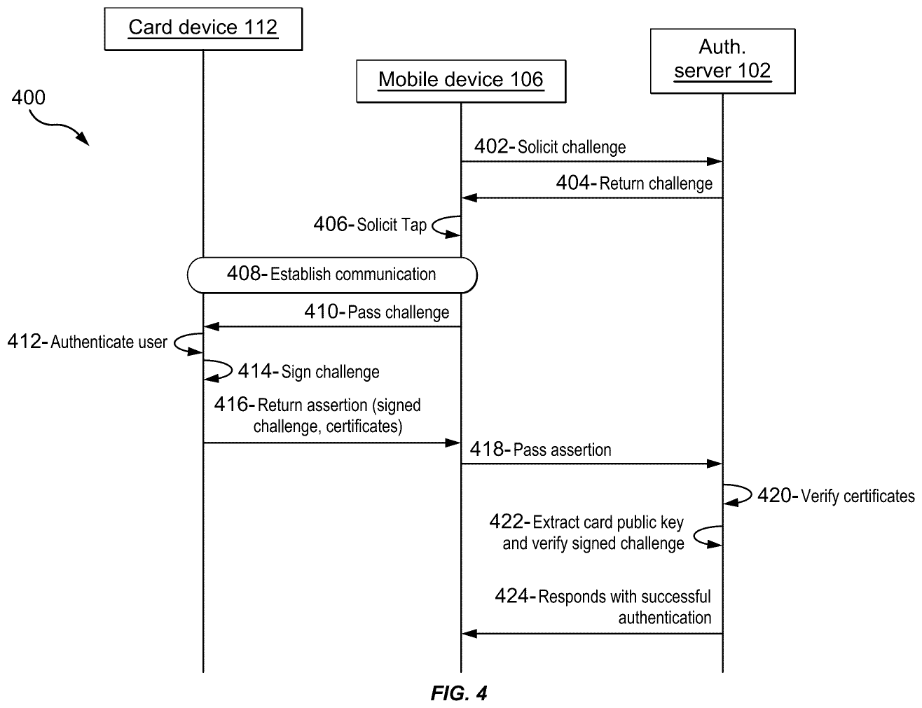

FIG. 4 illustrates an example method 400 for use in authentication of a user, through use of a card device as an authenticator, which is not previously registered. The example method 400 is described as implemented in the authentication server 102, the mobile device 106, and the card device 112 of the system 100, etc. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 400.

At the outset in the method 400, the user 110 attempts to access the application 118 at the mobile device 106. In response, to authenticate the user 110 as part of login to the application 118, the mobile device 106 solicits, at 402, a challenge from the authentication server 102. At 404, the authentication server 102 generates the challenge and returns the challenge to the mobile device 106.

Next, at 406, the mobile device 106 solicits the user 110 to tap the card device 112 at the mobile device 106, or otherwise bring the card device 112 within the NFC range of the mobile device 106. Once within the range, at 408, communication is established between the mobile device 106 and the card device 112, and the FIDO authenticator functionalities are initiated. In this embodiment, the communication is contactless, through NFC interfaces (e.g., network interface 210, etc.) in each of the card device 112 (e.g., the chip 114, etc.) and the mobile device 106. In other embodiments, the communication may include one or more other contactless protocols, or even contact based communication (e.g., where the card device 112 is at least partially inserted, or swiped, in a reader associated with the mobile device 106, etc.).

At 410, the mobile device 106 passes the challenge from the authentication server 102 to the card device 112. In response, at 412, optionally, the card device 112 authenticates the user 110, for example, as described above (e.g., step 312, etc.). It should be appreciated that authentication of the user 110 may be optionally included as shown in FIG. 4, or may be included in other parts of the method 400 is appropriate. What's more, in various embodiments, the authentication of the user 110 may be omitted based on the other verifications described herein.

The card device 112 retrieves the card private key from the chip 114 and signs, at 414, the challenge with the card private key. The card device 112 compiles a FIDO assertion, which includes the signed challenge, and additional data allowing to authenticate the card device 112 including, without limitation, the card certificate, the issuer certificate, and the PAN. At 416, the card device 112 returns the assertion and the RP ID, via the contactless connection, to the mobile device 106. It is to be noted that the RP ID is pre-configured in the card device 112, before issuance, as there is no FIDO registration in this example embodiment. At 418, the mobile device 106 passes the FIDO assertion, via the domain identified by the RP ID, to the authentication server 102.

The authentication server 102 verifies, at 420, the card certificate (e.g., based on a issuer key, etc.) and the issuer certificate (e.g., based on a network public key, etc.), consistent with the EMV standard protocol, as explained above. Once the card certificate and the issuer certificate are verified, the authentication server 102 extracts, at 422, the card public key from the card certificate and verifies the signature on the challenge (which was signed by the card private key at the card device 112) with the card public key.

When the signature on the challenge is verified, the authentication server 102 responds, at 424, with a notice of successful FIDO authentication, whereby the user 110 may be logged-in/authenticated to the application 118 at the mobile device 106, or otherwise provided access to an account or service associated therewith, etc.

As such, in one or more embodiments, a computer-implemented method for authentication of a user, through use of a card device as an authenticator, which is not previously registered is disclosed. The method comprises: in connection with an attempt to access an application at a mobile device, soliciting, by the mobile device a challenge from an authentication server, whereby the authentication server generates the challenge and returns the challenge to the mobile device; soliciting the user to cause a card device to interact with the mobile device (e.g., tap the card device on the mobile device); establishing, by the mobile device, communication with the card device (e.g., contactless communication (e.g., NFC communication via an NFC network interface, etc.), etc.); passing, by the mobile device, the challenge to the card device; optionally, authenticating, by the card device, the user; retrieving, by the card device, a private key specific to the card device from memory of the card device; signing, by the card device, the challenge with the private key; compiling, by the card device an assertion (e.g., including the signed challenge and the card certificate, the issuer certificate, and/or the PAN); returning, by the card device, the assertion to the mobile device. The assertion may be accompanied by the RP ID. The method further incudes passing, by the mobile device, the assertion, via the domain identified by the RP ID, to the authentication server, whereby the authentication server verifies the signature on the challenge; and responds with a notice of successful authentication; and based thereon, logging, by the mobile device, the user into the application at the mobile device.

In view of the above, the systems and methods herein extend the functionality of the card device to perform function not previously possible, and thus, improve the functioning of the card device.

In particular, the card device is adapted to communicate consistent with the CTAP standard protocol, in addition to its configuration consistent with the EMV standard protocol. In this way, the card device implements FIDO authentication protocol, using EMV-based personalization elements originally provisioned to the card device, in order to perform EMV transactions. And, by adapting the card device to the CTAP protocol, the card device is permitted to be authenticated through a certificate therein, which permits, in turn, leveraging a private key in the card device and specific to the card device to act as the FIDO authenticator, thereby extending the functions of the card device to do things it could not previously do. As such, the card device is configured to authenticate the user in connection with one or more relaying parties (e.g., login, account access, services, etc.). The systems and methods herein define a technical improvement as it relates to data security, by extending the card device use to being FIDO authenticator.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) in response to a request to register a card device as an authenticator, soliciting, by a mobile device, a challenge from an authentication server; (b) receiving, in response to the request, the challenge from the authentication server; (c) passing, by the mobile device, the challenge to the card device; (d) signing, by the card device, the challenge; (e) compiling, by the card device, an assertion, which includes the signed challenge, a card certificate, an issuer certificate and an identifier associated with the card device; (f) returning, by the card device, the assertion to the mobile device; and/or (g) passing the assertion to the authentication server, whereby verification of the card certificate, the issuer certificate and the signed challenge based on a public key included in the card certificate enables registration of the card device as a FIDO authenticator.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in registering a card device for use in authenticating a user, the method comprising:
in response to a request to register a card device as an authenticator, soliciting, by a mobile device, a challenge from an authentication server;
receiving, in response to the request, the challenge from the authentication server;
passing, by the mobile device, the challenge to the card device;
signing, by the card device, the challenge from the authentication server;
compiling, by the card device, an assertion, which includes the signed challenge, a card certificate, an issuer certificate, and an identifier specific to the card device;
returning, by the card device, the assertion to the mobile device; and
passing the assertion to the authentication server, whereby verification of the card certificate, the issuer certificate and the signed challenge based on a public key included in the card certificate enables registration of the card device as a fast identity online (FIDO) authenticator.

2. The computer-implemented method of claim 1, wherein passing the challenge to the card device includes passing, by the mobile device, the challenge through contactless communication with the card device; and/or
wherein the contactless communication includes near-field communication (NFC).

3. The computer-implemented method of claim 1, further comprising establishing communication between the card device and the mobile device; and
providing, by the mobile device, a selection of an application identifier (AID), which is specific to fast identity online (FIDO) authenticator functionality of the card device, to the card device.

4. The computer-implemented method of claim 1, further comprising authenticating, by the card device, the user, prior to signing the challenge with a private key specific to the card device.

5. The computer-implemented method of claim 4, wherein the authentication includes biometric authentication of a biometric of the user captured at a biometric sensor of the card device against a reference biometric stored in the card device; or
wherein authenticating the user is based on a knowledge-based factor from the user.

6. The computer-implemented method of claim 1, further comprising:
verifying, by the authentication server, the card certificate;
verifying, by the authentication server, the issuer certificate;
verifying, by the authentication server, the signature on the challenge based on the public key from the card certificate; and
based on the verification of the card certificate and the signature on the challenge being successful, storing, by the authentication server, the public key for subsequent authentication of the user through the card device as the authenticator.

7. The computer-implemented method of claim 1, wherein the assertion further includes a PAN, a card certificate and an issuer certificate.

8. The computer-implemented method of claim 7, further comprising:
verifying, by the authentication server, the card certificate;
verifying, by the authentication server, the issuer certificate based on a network public key;
verifying, by the authentication server, the signature on the challenge based on the public key from the card certificate; and
storing, by the authentication server, the public key linked to the PAN for subsequent authentication of the user through the card device as the authenticator.

9. The computer-implemented method of claim 8, wherein the assertion include a device ID specific to the card device and/or a credential ID unique to a private key specific to the card device; and
wherein the credential ID is a PAN.

10. A system for registering a card device for use in authenticating a user, the system comprising:
a card device; and
a mobile device including a processor and memory, which includes executable instructions, which when executed by the processor, cause the processor to:
in response to a request to register a card device as an authenticator, solicit, via a network interface of the mobile device, a challenge from an authentication server;
receive, via the network interface, in response to the request, the challenge from the authentication server;
pass, via a different network interface, the challenge to the card device; and
wherein the card device includes a processor chip which is configured to:
sign the challenge from the authentication server;
compile an assertion, which includes the signed challenge, a card certificate, an issuer certificate, and an identifier specific to the card device; and
return the assertion to the mobile device; and
wherein the executable instruction, when executed by the processor of the mobile device, further cause the processor to pass, via the network interface, the assertion to the authentication server, whereby verification of the card certificate, the issuer certificate and the signed challenge based on a public key included in the card certificate enables registration of the card device as a fast identity online (FIDO) authenticator.

11. The system of claim 10, wherein the executable instruction, when executed by the processor, cause the processor, in passing the challenge to the card device, to pass the challenge through contactless communication with the card device; and/or
wherein the different network interfaces included near-field communication (NFC) network interface.

12. The system of claim 10, wherein the executable instruction, when executed by the processor to:
establish communication with the card device; and
select an application identifier (AID) specific to fast identity online (FIDO) authenticator functionality of the card device.

13. The system of claim 10, further comprising authenticating, by the card device, the user, prior to signing the challenge with a private key specific to the card device.

14. The system of claim 13, wherein the authentication includes biometric authentication of a biometric of the user captured at a biometric sensor of the card device against a reference biometric stored in the card device; or
wherein authenticating the user is based on a knowledge-based factor from the user.

15. The system of claim 10, further comprising an authentication server, which is configured to:
verify the card certificate;
verify, the issuer certificate;
verify the signature on the challenge based on the public key from the card certificate; and
based on the verification of the card certificate and the signature on the challenge being successful, store the public key for subsequent authentication of the user through the card device as the authenticator.

16. The system of claim 10, wherein the assertion further includes a PAN, a card certificate, and an issuer certificate.

17. The system of claim 16, further comprising an authentication server, which is configured to:
verify the card certificate;
verify the issuer certificate based on a network public key;
verify the signature on the challenge based on the public key from the card certificate; and
store, the public key linked to the PAN for subsequent authentication of the user through the card device as the authenticator.

18. The system of claim 17, wherein the assertion include a device ID specific to the card device and/or a credential ID unique to a private key specific to the card device; and
wherein the credential ID is a PAN.

19. A computer-implemented method for use in integrating enhanced authentication to configure card devices as passkey authenticators, the method comprising:
soliciting, by a mobile device specific to a user, an interaction with a card device of the user, the card device linked to an account issued to the user;
in response to a physical proximity of the card device to the mobile device, based on the solicitation, establishing communication, as a near field communication (NFC) interaction, between the mobile device and the card device;
passing, by the mobile device, a challenge to the card device;
signing, by the card device, the challenge;
returning, by the card device, the signed challenge to the mobile device; and
passing, by the mobile device, the signed challenge to an authentication server, whereby verification of the signed challenge based on a public key enables authentication of the user by the authentication server.

20. The computer-implemented method of claim 19, further comprising:
authenticating, by the card device, the user, prior to signing the challenge; and/or
compiling, by the card device, a fast identity online (FIDO) assertion, which includes the signed challenge, a card certificate, an issuer certificate, and a PAN, wherein returning the signed challenge included returning the FIDO assertion, and wherein the public key is part of the card certificate.
